(19) United States
(12) Patent Application Publication
(10) Pub. No.: US 2017/0021879 A1
(43) Pub. Date: Jan. 26, 2017

(54) TRACK LINK ASSEMBLY FOR A MACHINE

(71) Applicant: Caterpillar Inc., Peoria, IL (US)

(72) Inventors: Timothy Arthur THORSON, Morton, IL (US); Robert Lee MEYER, Metamora, IL (US); Mark Steven DIEKEVERS, Germantown Hills, IL (US); Gregory Jerome KAUFMANN, Metamora, IL (US)

(73) Assignee: Caterpillar Inc., Peoria, IL (US)

(21) Appl. No.: 14/808,451

(22) Filed: Jul. 24, 2015

(51) Int. Cl. B62D 55/21; B21D 39/00; B21L 9/02; B21D 19/00; B62D 55/32; B62D 55/06

(52) U.S. Cl. CPC B62D 55/21; B62D 55/32; B62D 55/06; B21L 9/02; B21D 19/00; B21D 39/00

(57) ABSTRACT

A track link assembly is disclosed for a machine. The track link assembly may include a first track link having a first thru hole and a second track link having a second thru hole aligned with the first thru hole. The track link assembly may further include a track pin disposed within the first and second thru holes. The track pin may have an end protruding from the first and second track links. The track link assembly may also include a ring-shaped flange integrally formed from the end of the track pin after insertion of the track pin into the first and second track links. The ring-shaped flange may have an outer diameter larger than a diameter of the first and second thru holes.

### TECHNICAL FIELD

This disclosure relates generally to a track link assembly for a machine and, more particularly, to a system and a method for forming a track link assembly.

### BACKGROUND

Track-type machines are in widespread use in construction, mining, forestry, and other similar industries. The undercarriage of such track-type machines utilizes tracks, rather than wheels, to provide ground-engaging propulsion. Tracks may be preferred in environments where creating sufficient traction is problematic. The tracks include an endless loop of coupled track link assemblies, which support ground-engaging track shoes.

Typical track link assemblies include two pairs of track links connected to each other by a track pin. The connections between the track links and the track pin must be sufficient to retain the track pin within the track links during operation of the machine. The loads that the connections must withstand depend on numerous factors, such as a weight of the machine, a size or a material of the track links, a size or a material of the track pin, an environment in which the machine is operating, characteristics of the ground surface engaged by the shoes, and other factors. In addition, if appropriate track pin retention mechanisms are not employed, the track pin may work itself free from the track links. If the track pin were to release from the track link assembly, the track could unroll quickly and pieces of the track pin may break off.

One exemplary pin retention mechanism is described in U.S. Pat. No. 4,141,125 (the '125 patent) filed by Blunier on Dec. 6, 1977. The '125 patent describes a track pin that has ends mounted in bores defined by respective track links. The ends of the track pin are heated above the critical temperature of the steel making up the track pin, and then quenched. The strength of the metallurgical bond formed by this process prevent the track pin from working itself free from the track links.

Although the solution described in the '125 patent may be acceptable for some applications, it may still be problematic. In particular, typical track pins are made from materials having high strength and hardness characteristics, and heating track pins above the critical temperature, as suggested in the '125 patent, can be difficult to implement with such materials. In addition, the process could change the material characteristics of the track pin in an undesirable way.

The track link assemblies and methods of the present disclosure are directed towards overcoming one or more of the problems set forth above.

### SUMMARY

In one aspect, the present disclosure is directed to a track link assembly for a machine. The track link assembly may include a first track link having a first thru hole and a second track link having a second thru hole aligned with the first thru hole. The track link assembly may further include a track pin disposed within the first and second thru holes. The track pin may have an end protruding from the first and second track links. The track link assembly may also include a ring-shaped flange integrally formed from the end of the track pin after insertion of the track pin into the first and second track links. The ring-shaped flange may have an outer diameter larger than a diameter of the first and second thru hole.

In another aspect, the present disclosure is directed to a method of forming a track link assembly. The method may include disposing a track pin within a first thru hole of a first track link and within a second thru hole of a second track link. The method may further include applying heat to soften at least part of an end of the track pin that protrudes from the first and second track links. The method may also include applying force to deform at least part of the end into a ring-shaped flange.

In yet another aspect, the present disclosure is directed to a machine. The machine may include a power source configured to rotate a sprocket, and a track coupled with the sprocket and including a plurality of track link assemblies. Each track link assembly may include a first track link having a first thru hole, a second track link having a second thru hole, a third track link having a third thru hole, and a fourth track link having a fourth thru hole. The track link assembly may further include a track pin disposed within the first, second, third, and fourth thru holes. The track pin may have a first end protruding from the first and second track links, and a second end protruding from the third and fourth track links. The track link assembly may also include first ring-shaped flange, integrally formed from the first end of the track pin after insertion of the track pin into the first and second track links, having a first outer diameter larger than a diameter of the first and second thru hole. The track link assembly may also include a second ring-shaped flange, integrally formed from the second end of the track pin after insertion of the track pin into the third and fourth track links, having a second outer diameter larger than a diameter of the third and fourth thru holes.

### BRIEF DESCRIPTION OF THE DRAWINGS

FIG. 1 is a diagrammatic illustration of an exemplary machine consistent with the disclosed embodiments;

FIG. 2 is an exploded view of an exemplary track link assembly that may be used in conjunction with the machine of FIG. 1;

FIGS. 3A and 3B are cross-sectional views of the track link assembly of FIG. 2, before and after the ends of a track pin are deformed;

FIGS. 4A and 4B are top views of the track pin of FIG. 3A, before and after deformation;

FIG. 5 includes diagrammatic illustrations of several exemplary track pin designs before and after deformation; and

FIG. 6 is a flowchart showing an exemplary process for forming the track link assembly of FIG. 2.

### DETAILED DESCRIPTION

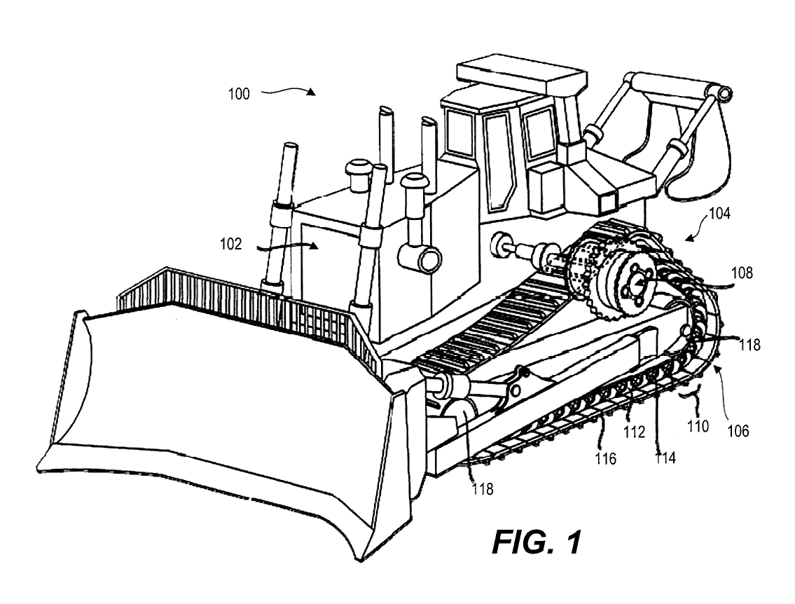

FIG. 1 schematically illustrates an exemplary machine 100 consistent with the disclosed embodiments. In the example depicted in FIG. 1, machine 100 is a dozer. It is contemplated, however, that machine 100 may embody other types of machines performing operations associated with an industry such as mining, construction, farming, or any other industry known in the art. For example, machine 100 may be an earth moving machine such as a loader, an excavator, or another earth-moving machine.

Machine 100 may include a power source 102 capable of driving a tracked undercarriage 104 at a range of output speeds and torques. Power source 102 may be an engine such as, for example, a diesel engine, a gasoline engine, a gaseous fuel-powered engine, or any other suitable engine. Tracked undercarriage 104 may include tracks 106 (only one shown in FIG. 1) driven by power source 102 via sprockets 108 (only one shown in FIG. 1). Tracks 106 may include more than one track link assembly 110. Each track link assembly 110 may include at least one pair of track links 112 connected to each other by a track pin 114. In addition, each track link assembly 110 may be connected to a shoe 116, which is configured to engage a ground surface under machine 100. When sprockets 108 are rotated by power source 102, they may engage and transmit torque to track link assembly 110, resulting in movement of tracks 106 around sets of pulley mechanisms 118.

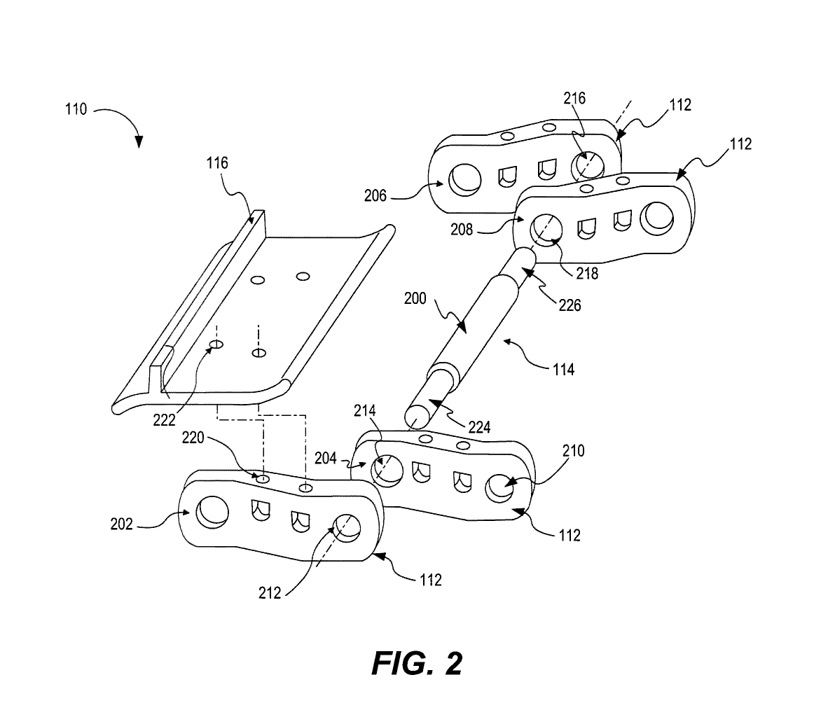

FIG. 2 is an exploded view of exemplary track link assembly 110 that includes two pairs of track links 112, track pin 114, a bushing 200, and shoe 116. As shown in FIG. 2, the first pair of track links 112 (e.g., a first track link 202 and a second track link 204) may be a mirror image of a second pair of track links 112 (e.g., a third track link 206 and a fourth track link 208). The two pairs of track links 112 may be disposed opposite to each other within track link assembly 110, such that the first pair of track links 112 forms one side of track link assembly 110 and the second pair of track links 112 forms the opposite side of track link assembly 110. When the components shown in FIG. 2 are assembled with one another, track pin 114 may be used to connect all of track links 112. Shoe 116 may be connected to first track link 202 and to third track link 206, and another shoe (not shown) may be connected to second track link 204 and to fourth track link 208. Although FIG. 2 shows specific examples of track links 112 and track pin 114, the present disclosure is not limited to the specific types of track links 112 and track pin 114 that are illustrated in FIG. 2. Instead, track link assembly 110 may be used with any types of track links 112 and track pin 114.

In some embodiments, bushing 200 may be disposed on track pin 114, such that bushing 200 may rotate relative to track pin 114. For example, bushing 200 may be retained on track pin 114 by second track link 204 and fourth track link 208 disposed on either side of bushing 200. By this arrangement, one of the rotationally-driven sprockets 108 may engage bushing 200, and bushing 200 may rotate on track pin 114. Due to the force applied to bushing 200, track pin 114 may translate, resulting in movement of track link assembly 110 around pulley mechanisms 118.

Each of track links 112 may include one or more of thru holes 210 configured to accept at least a portion of track pin 114. For example, first track link 202 includes a first thru hole 212, second track link 204 includes a second thru hole 214, third track link 206 includes a third thru hole 216, and fourth track link 208 includes a fourth thru hole 218. Thru holes 210 may be shaped, sized, positioned, and/or otherwise configured to accept track pin 114 and bushing 200.

In an exemplary embodiment, thru holes 210 may be sized to provide a pressed fit between at least a portion of bushing 200 and the corresponding track links 112. Specifically, thru holes 210 may have a diameter slightly smaller than a corresponding diameter of bushing 200 to facilitate the press fit. In further exemplary embodiments, bushing 200 may comprise more than one outer diameter, and at least one of the outer diameters defined by bushing 200 may correspond to the diameter of the respective thru holes 210. In this way, bushing 200 may remain substantially stationary relative to the track links 112 coupled thereto during use of tracks 106.

Additionally, each of track links 112 may further include one or more openings 220, while each shoe 116 may include corresponding openings 222. By this arrangement, threaded fasteners, such as bolts (not shown), may be disposed within openings 220 and 222 to attach shoe 116 to track links 112. Corresponding threaded fasteners, such as nuts (not shown), may be disposed on the ends of the bolts.

As shown in FIG. 2, track pin 114 may have a first end 224 and a second end 226. When the components shown in FIG. 2 are assembled, track pin 114 is disposed within first thru hole 212 and second thru hole 214, and first end 224 may protrude from first track link 202 and second track link 204. Similarly, when track pin 114 is disposed within third thru hole 216 and fourth thru hole 218, second end 226 may protrude from third track link 206 and fourth track link 208. Consistent with embodiments of the present disclosure, a method is provided for forming track link assembly 110. In some embodiments, the method includes deforming protruding portions of first end 224 and second end 226 in a way that prevents track pin 114 from working itself free from track links 112.

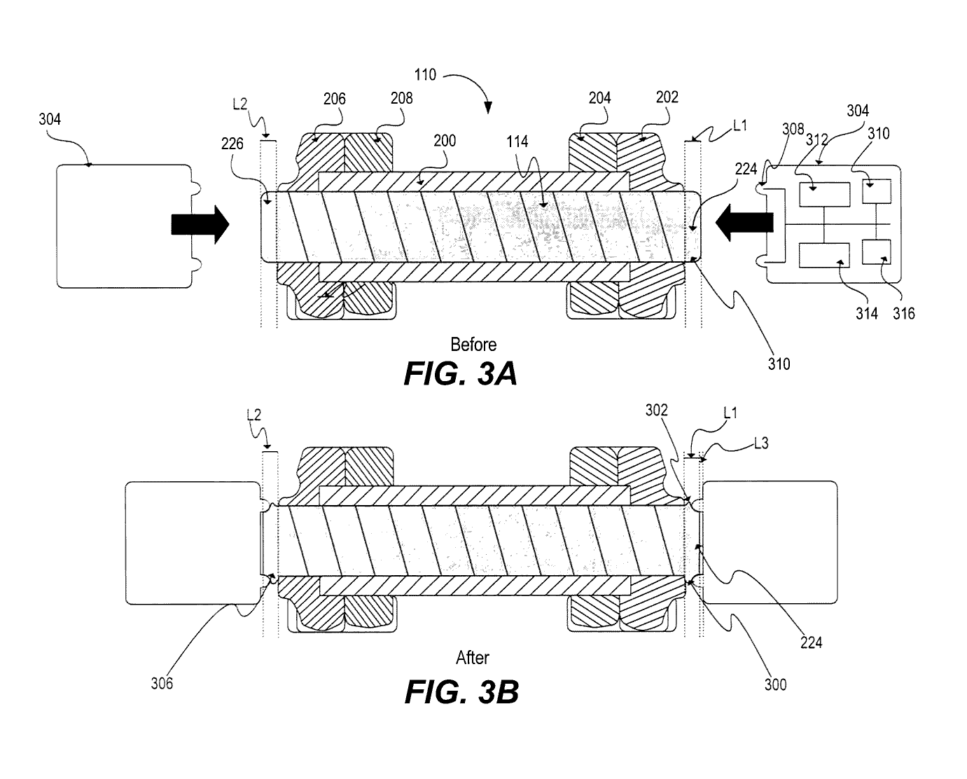

FIG. 3A is a cross-sectional view of track link assembly 110 before deformation of first end 224 and second end 226, while FIG. 3B is a cross-sectional view of track link assembly 110 after deformation of first end 224 and second end 226. As shown in these figures, before the deformation, first end 224 protrudes from first and second track links 202, 204 by a distance L1, and second end 226 protrudes from third and fourth track links 206, 208 by a distance L2. In some embodiments, distance L1 may have a value of about 5-50 mm (e.g., about 10-45 mm). The value of distance L1 may be equal to the value of distance L2. Alternatively, the value of distance L1 may be more or less than the value of distance L2.

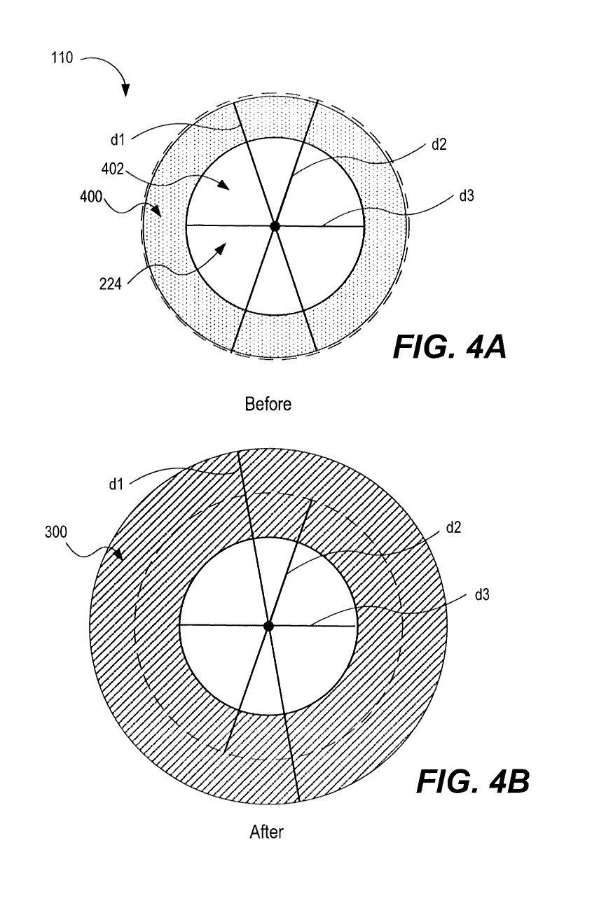

After the deformation, each end may be reshaped to include a ring-shaped flange, which may be an integral part of track pin 114. For example, a first ring-shaped flange 300 is made from first end 224. In the context of the present disclosure, the term “deforming” means applying heat and force to change the shape of at least part of track pin 114. First ring-shaped flange 300 may have an outer diameter larger than a diameter of track pin 114. For example, the diameter of track pin 114 may be about 20-70 mm, and the outer diameter of first ring-shaped flange 300 may be about 0.5-10% larger. FIGS. 4A and 4B are top views of track pin 114 before and after deformation, respectively, and may provide a better understanding of the difference in diameters associated with first end 224. FIGS. 4A and 4B are discussed in greater detail below.

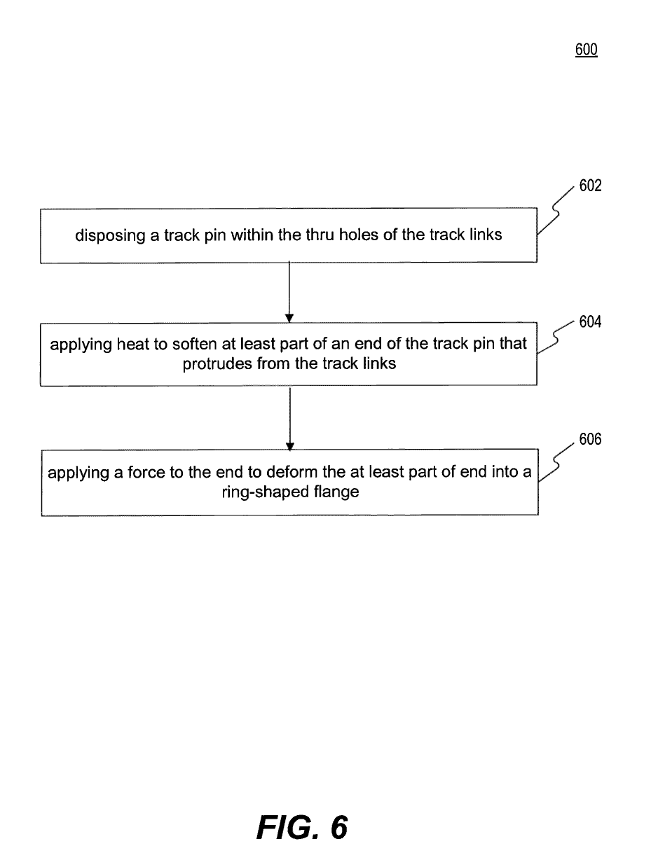

The process of deforming first end 224 to make first ring-shaped flange 300 is referred herewith as a warm-formed process, and is further disclosed in detail with reference to FIG. 6. The warm-formed process has several advantages over a process where no heat is applied prior to the appliance of force (i.e., a cold-formed process). One advantage is that a side profile of first ring-shaped flange 300 may include a single radial peak 302. In one example, radial peak 302 may be located at a distance about a third of distance L1 closer to the end surface of first track link 202. While the height of radial peak 302 may be between 1.1-3.5 times the diameter of track pin 114. Another advantage of the warm-formed process over the cold-formed process is that, by applying heat to at least part of track pin 114, the heated area is softened, which can make the area easier to deform via pressing.

In some embodiments, structural differences may be observed between first ring-shaped flange 300 formed by a warm-formed process and a different ring-shaped element formed by a cold-formed process. For example, first ring-shaped flange 300 may include an oxide layer that indicates that the ring-shaped flange was previously heated. Therefore, there may be color differences in areas that were heated. In addition, areas that have been affected by heat may be detected when performing micro-analysis on first end 224 (i.e., when looking at the microstructure of the steel) and measuring the hardness below the surface of first end 224. For example, the hardness of an area affected by heat may be non-uniform. In the example illustrated in FIGS. 3A and 3B, first ring-shaped flange 300 is shaped when heat and force are applied only to part of the first end 224. Accordingly, first end 224 may have a particular oxidation pattern and hardness characteristic. For example, the end of the track pin may include an oxide layer on the ring-shaped flange and may include an oxide-free area at a diameter smaller than the inner diameter of the ring-shaped flange. Also, after deformation first end 224 and first ring-shaped flange 300 may have a substantially uniform surface hardness of about 50 to 62 Rkw C, for example, 54 Rkw C.

FIGS. 3A and 3B also depict a system 304 that has the capabilities of deforming at least part of track pin 114. The heat and force applied by system 304 may depend on the type and size of track pin 114 that is being deformed. A person skilled in the art will understand that deforming a track pin having a diameter of 70 mm would require significantly more resources than deforming a track pin having a diameter of 20 mm.

System 304 may be configured to concurrently (or subsequently) apply heat to soften at least a part of first end 224 and to apply a pressing force to deform the at least a part of first end 224. In addition, system 304 may be configured to concurrently (or subsequently) deform first end 224 and second end 226. The term “concurrently” means that the two processes occur during coincident or overlapping time periods, either where one begins and ends during the duration of the other, or where a later one starts before the completion of the other. In a first example, a force used to press at least a part of first end 224 is applied while heat is still being applied. In a second example, first ring-shaped flange 300 may be shaped from first end 224 at the same time that second ring-shaped flange 306 is being shaped from second end 226. In some embodiments, system 304 may include a ring-shaped element 308, a power supply 310, a press 312, a resistance heating apparatus 314, and a controller 316.

Ring-shaped element 308 may protrude from the surface of system 304, such that system 304 may apply heat, force, or both to only a part of first end 224. Distance L3 represents the space between the surface of first end 224 and the surface of system 304 after system 304 deforms first end 224. L3 may have any value larger than zero. The diameter of ring-shaped element 308 may correspond with the diameter of track pin 114. In the embodiment illustrated in FIGS. 3A and 3B, ring-shaped element 308 has a round profile. In another embodiment, ring-shaped element 308 may have a stepped profile.

Power supply 310 may be any type of power supply that is capable of providing a variable supply of power, such as a battery, an AC power supply, or a DC power supply such as a linear power supply, a switching power supply, a DC-DC converter, a silicon controlled rectifier (SCR), or other type of power supply. Power supply 310 may be directly or indirectly connected to press 312 and resistance heating apparatus 314 by way of controller 316. Thus, depending on a desired set of conditions, controller 316 may regulate power supply 310 to alter a polarity, a current, a voltage, and/or other parameters of the power directed to press 312 or resistance heating apparatus 314.

Press 312 may be configured to apply a linear force to at least one end of track pin 114. In some embodiments, press 312 may include a force sensor configured to measure a reaction force at first end 224. Data related to the reaction force and deformation may be used by controller 316 to determine the force applied to first end 224. Press 312 may be fitted with an end tooling or ring-shaped element 308, as shown in FIGS. 3A and 3B. The type of profile ring-shaped element 308 may affect how force from press 312 is applied to track pin 114. In a first example, a round profile (as shown in FIGS. 3A and 3B) may cause more force to be applied at a perimeter of first end 224 than at the inner diameter of first ring-shaped flange 300. In a second example, a stepped profile may cause force to be applied uniformly.

Resistance heating apparatus 314 may include a pair of electrodes electrically connected to power supply 310. When power is supplied to the pair of electrodes, current flows between a portion of first end 224 in contact with the pair of electrodes and heat is generated. The temperature in the portion of first end 224 may be below the critical temperature of the material of track pin 114. The term “critical temperature” is defined herewith as the temperature at which phase change occurs. For example, when the material of track pin 114 is SAE 1040 steel or AISI 1050 steel, the critical temperatures may range from approximately 1400° F. to approximately 1600° F. In this case, at least a portion of first end 224 may be heated below 1400° F., for example, to a temperature of about 400-1300° F.

Controller 316 may embody a single microprocessor or multiple microprocessors that include a means for controlling an operation of system 304. Numerous commercially available microprocessors may perform the functions of controller 316. Controller 316 may include or be associated with a memory for storing data such as, for example, an operating condition, design limits, performance characteristics or specifications of system 304 or operational instructions. Various other known circuits may be associated with controller 316, including power supply circuitry, signal-conditioning circuitry, communication circuitry, and other appropriate circuitry. Moreover, controller 316 may be capable of communicating with other components of system 304 via either wired or wireless transmission and, as such, controller 316 may be disposed in a location remote from system 304, if desired.

FIG. 4A is a top view of track pin 114 before deformation, while FIG. 4B is a top view of track pin 114 after deformation. The perimeter of track pin 114 is marked with a continuous line and the perimeter of thru holes 210 is marked with a dashed line. As shown in FIG. 4A, before deformation, an outer diameter d1 of track pin 114 is substantially the same size as a diameter d2 of thru holes 210. As mentioned above, heat, force, or a combination of both may be applied only to part of first end 224. For example, first end 224 may include a peripheral area 400 and a central area 402, and applying heat and/or force to deform the at least part of the end of the track pin may include applying heat and/or force to peripheral area 400 and not to central area 402.

The warm-formed process may deform first end 224, such that diameter d1 of track pin 114 increases. In some embodiments, the new size of outer diameter d1 is about 0.5-15% larger than the original size of outer diameter d1. In other words, first ring-shaped flange 300 has an outer diameter (i.e., outer diameter d1) larger than a diameter of thru holes 210 (i.e., diameter d2). For example, the outer diameter of first ring-shaped flange 300 may be about 2.5-12% larger than the diameter of thru holes 210. First ring-shaped flange 300 also has an inner diameter (i.e., diameter d3) smaller than the diameter of thru holes 210 (i.e., diameter d2). Consistent with some embodiments of the present disclosure, ring-shaped element 308 of system 304 is applied only to peripheral area 400, and first ring-shaped flange 300 is formed from material only under peripheral area 400.

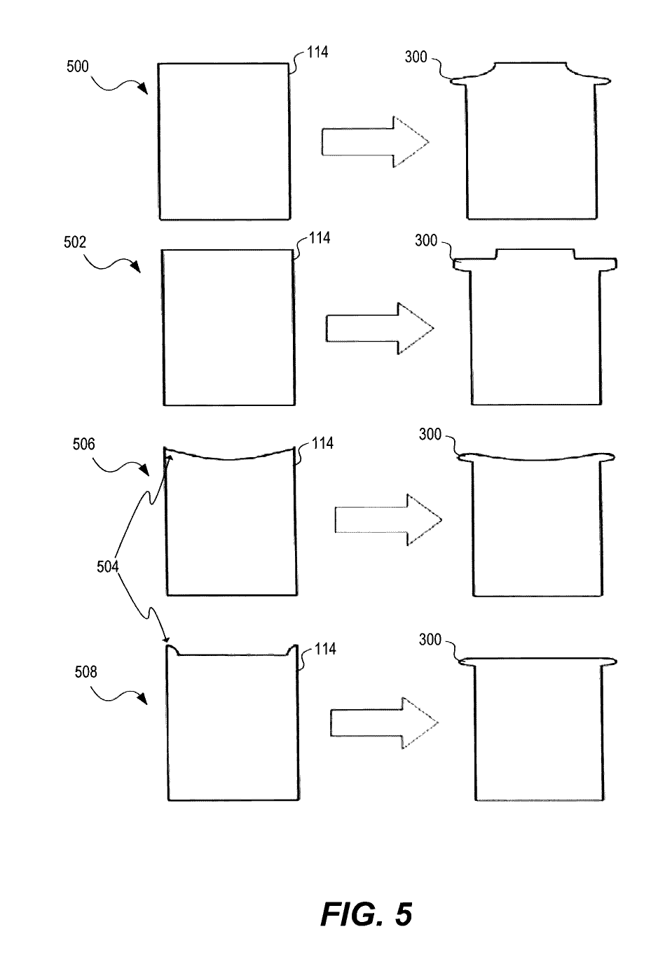

FIG. 5 includes diagrammatic illustrations of several exemplary designs of track pin 114 before and after deformation. In some embodiments, first end 224 may have a flat surface and system 304 may include a ring-shaped element 308 that protrudes from its surface. First design 500 and second design 502 illustrate exemplary designs of track pin 114 according to these embodiments. The shape of the first ring-shaped flange 300 may be affected by the profile of ring-shaped element 308. In other embodiments, first end 224 may include a have an uneven surface and system 304 may include a flat surface. For example, first end 224 may include a ring-shaped element 504. Third design 506 and fourth design 508 illustrate exemplary designs of track pin 114 according to these embodiments. The shape of the first ring-shaped flange 300 may be affected by the profile of ring-shaped element 504. In all of the illustrated designs applying heat and/or force to deform the end of track pin 114 may include applying heat and/or force to a peripheral area and not to a central area. The following discussion, with reference to FIG. 6, provides an exemplary process 600 for forming track link assembly 110.

### INDUSTRIAL APPLICABILITY

The disclosed track link assembly may be applicable to any machine having a tracked undercarriage that includes track links connected by track pins. The track link assembly described herein provides robust pin retention, with reduced number of components. Thus, the disclosed track link assembly may be reliable and low cost. In addition, the disclosed track link assembly may improve durability of the associated tracked undercarriage by eliminating walking out of the track pin during use.

At step 602, track pin 114 may be disposed within thru holes 210 of the track links 112, which may be aligned with one another. For example, one end of track pin 114 may be disposed within first thru hole 212 of first track link 202 and within second thru hole 214 of second track link 204, while the other end of track pin 114 may be disposed within third thru hole 216 of third track link 206 and within fourth thru hole 218 of fourth track link 208. Track pin 114 may be inserted within thru holes 210 in any way known in the art. Bushing 200 may be disposed on track pin 114 prior to insertion of track pin 114 within thru holes 210. Regardless of when it is disposed on track pin 114, bushing 200 may rotate relative to track pin 114 and thru holes 210 even after assembly is complete. In accordance with embodiments of the present disclosure, track pin 114 may be disposed within thru holes 210 such that part of track pin 114 protrudes from thru holes 210. For example, first end 224 may protrude from first track link 202 and second track link 204, and second end 226 may protrude from third track link 206 and fourth track link 208.

At step 604, heat is applied to soften at least part of the ends of the track pin 114. By way of example, the discussion of this step will be directed to first end 224. However, heat may be similarly applied to second end 226 with the necessary modifications. Heat may be applied to soften at least part of the ends of the track pin 114 according to any method known in the art. For example, heat may be applied using a laser beam or using electrical induction. Alternatively, heat may be applied by an electrode using a low-voltage, high-current pulsing power supply that may be incorporated in system 304 (e.g., power supply 310). The pulsing electrical current that passes through track pin 114 may resistively heat at least part of first end 224. This heating may slightly soften part of first end 224, thus making it easier to shape first end 224 to a larger diameter. In some embodiments, applying heat to first end 224 may include applying heat to all of the surface of first end 224. Alternatively, applying the heat to first end 224 may include applying heat only to an area adjacent outer diameter d1. In a first example, the part of first end 224 that is heated may be peripheral area 400. In a second example, the part of first end 224 that is heated may be only a portion of peripheral area 400. In one embodiment, step 604 includes heating the part of first end 224 below the critical temperature of the material of track pin 114.

At step 606, force may be applied to deform parts of track pin 114 into ring-shaped flanges (300 and 306). The discussion of this step will also be directed to first end 224. However, force may be similarly applied to second end 226 with the necessary modifications. The force may be applied by press 312. Press 312 may deform at least part of the first end 224 axially outward over the edges of thru holes 210, thereby forming first ring-shaped flange 300. In some embodiments, applying force to first end 224 may include applying force to all of the surface of first end 224. In other embodiments, applying the force to first end 224 may include applying force only to peripheral area 400, for example, by using ring-shaped element 308. In addition, the force may be applied uniformly to all of peripheral area 400. Alternatively, more force may be applied at a perimeter of first end 224 than at an inner diameter first end 224. Consistent with some embodiments, process 600 may be concurrently executed at both ends of track pin 114 to form ring-shaped flanges at both sides (i.e., first ring-shaped flange 300 and second ring-shaped flange 306). When both flanges have been formed, track pin 114 may be secured in track link assembly 110.

Although process 600 describes forming track link assembly 110 with track pin 114, it will be apparent to those skilled in the art that various modifications and variations can be made to process 600. For example, process 600 could be scaled up in size to or down in size to include a number of other pin joints (e.g. hinge pin or bogie pins). Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A track link assembly for a machine, comprising:
a first track link having a first thru hole;
a second track link having a second thru hole aligned with the first thru hole;
a track pin disposed within the first and second thru holes, the track pin having an end protruding from the first and second track links; and
a ring-shaped flange, integrally formed from the end of the track pin after insertion of the track pin into the first and second track links, having an outer diameter larger than a diameter of the first and second thru holes.

2. The track link assembly of claim 1, wherein the outer diameter of the ring-shaped flange is at least 0.5% larger than the diameter of the first and second thru holes.

3. The track link assembly of claim 1, wherein the ring-shaped flange includes an oxide layer.

4. The track link assembly of claim 1, wherein the ring-shaped flange has an inner diameter smaller than the diameter of the first and second thru holes.

5. The track link assembly of claim 4, wherein:
the end of the track pin includes an oxide layer on the ring-shaped flange; and
the end of the track pin includes an oxide-free area at a diameter smaller than the inner diameter of the ring-shaped flange.

6. The track link assembly of claim 1, wherein a side profile of the ring-shaped flange includes a single radial peak.

7. The track link assembly of claim 1, further including:
a third track link having a third thru hole;
a fourth track link having a fourth thru hole;
the end of the track pin is a first end; and
the track pin is disposed within the third and fourth thru holes and includes a second end that protrudes from the third and fourth track links.

8. The track link assembly of claim 7, wherein the ring-shaped flange is a first ring-shaped flange and the track link assembly further includes a second ring-shaped flange, integrally formed from the second end of the track pin after insertion of the track pin into the third and fourth track links, having an outer diameter larger than a diameter of the third and fourth thru holes.

9. A method of forming a track link assembly, comprising:
disposing a track pin within a first thru hole of a first track link and within a second thru hole of a second track link;
applying heat to soften at least part of an end of the track pin that protrudes from the first and second track links; and
applying force to deform at least part of the end of the track pin into a ring-shaped flange.

10. The method of claim 9, wherein the ring-shaped flange has an outer diameter larger than a diameter of the first and second thru holes and an inner diameter smaller than a diameter of the first and second thru holes.

11. The method of claim 9, wherein applying heat to soften the at least part of the end of the track pin includes applying heat below a critical temperature of a material of the track pin.

12. The method of claim 9, wherein the end of the track pin includes a peripheral area and a central area, and applying force to deform the at least part of the end of the track pin includes applying force to the peripheral area and not to the central area.

13. The method of claim 12, wherein applying force to the peripheral area includes applying force uniformly to all of the peripheral area.

14. The method of claim 12, wherein applying force to the peripheral area includes applying more force at a perimeter of the end of the track pin than at the inner diameter.

15. The method of claim 9, wherein the end of the track pin is a first end and the ring-shaped flange is a first ring-shaped flange, and the method further includes:
disposing the track pin also within a third thru hole of a third track link and within a fourth thru hole of a fourth track link;
applying heat to soften at least part of a second end of the track pin that protrudes from the third and fourth track links; and
applying force to deform the at least part of the second end into a second ring-shaped flange.

16. The method of claim 15, wherein applying force to deform the at least part of the first end includes applying force to deform the least part of the second end substantially concurrently.

17. A machine, comprising:
a power source configured to rotate a sprocket;
a track coupled with the sprocket and including a plurality of track link assemblies, each track link assembly includes:
a first track link having a first thru hole;
a second track link having a second thru hole;
a third track link having a third thru hole;
a fourth track link having a fourth thru hole,
a track pin disposed within the first, second, third, and fourth thru holes, the track pin having a first end protruding from the first and second track links and a second end protruding from the third and fourth track links;
a first ring-shaped flange, integrally formed from the first end of the track pin after insertion of the track pin into the first and second track links, having a first outer diameter larger than a diameter of the first and second thru hole; and
a second ring-shaped flange, integrally formed from the second end of the track pin after insertion of the track pin into the third and fourth track links, having a second outer diameter larger than a diameter of the third and fourth thru holes.

18. The machine of claim 17, wherein the first outer diameter of the first ring-shaped flange is at least 0.5% larger than the diameter of the first and second thru holes and the second outer diameter of the second ring-shaped flange is at least 0.5% larger than the diameter of the third and fourth thru holes.

19. The machine of claim 17, wherein each of the first and second ring-shaped flanges includes an oxide layer.

20. The machine of claim 17, wherein:
the first ring-shaped flange has an inner diameter smaller than the diameter of the first and second thru holes;
the end of the track pin includes an oxide layer on the first ring-shaped flange; and
the end of the track pin includes an oxide-free area at a diameter smaller than the inner diameter of the first ring-shaped flange.
